(19) United States
(12) Patent Application Publication
(10) Pub. No.: US 2025/0045617 A1
(43) Pub. Date: Feb. 6, 2025

(54) QUBIT STATE READING APPARATUS AND QUBIT STATE READING METHOD

(71) Applicant: POSTECH RESEARCH AND BUSINESS DEVELOPMENT FOUNDATION, Pohang-si (KR)

(72) Inventors: Jae Yoon SIM, Pohang-si (KR); Dong Gyu MINN, Pohang-si (KR)

(73) Assignee: POSTECH RESEARCH AND BUSINESS DEVELOPMENT FOUNDATION, Pohang-si (KR)

(21) Appl. No.: 18/786,131

(22) Filed: Jul. 26, 2024

(30) Foreign Application Priority Data
Aug. 1, 2023 (KR) 10-2023-0100735
Jun. 17, 2024 (KR) 10-2024-0078051

(51) Int. Cl. G06N 10/40

(52) U.S. Cl. CPC G06N 10/40

(57) ABSTRACT

Provided is a qubit state reading apparatus including a probe signal provider configured to provide a probe signal to a qubit and a readout module configured to receive a qubit signal output from the qubit to which the probe signal is provided and read a state of the qubit, in which the readout module includes a local oscillation (LO) signal generator configured to generate an LO signal, a mixer configured to down-convert the qubit signal using the LO signal, an accumulator configured to accumulate output signals of the mixer, and a comparator configured to compare an output signal of the accumulator with a threshold and output a signal corresponding to the state of the qubit, and the readout module down-converts the qubit signal and the LO signal in a homodyne manner.

### CROSS-REFERENCE TO RELATED APPLICATION

This application claims priority to and the benefit of Korean Patent Application Nos. 2023-0100735, filed on Aug. 1, 2023, and 2024-0078051, filed on Jun. 17, 2024. The entire contents of each of the foregoing applications are incorporated herein by reference for all purposes.

### BACKGROUND

### 1. Field of the Invention

The present disclosure generally relates to a qubit state reading apparatus and a qubit state reading method.

### 2. Discussion of Related Art

Quantum computers perform algorithms and calculation using quantum bits (qubits) with properties such as quantum superposition and quantum entanglement, and exceed performance achieved when many applications and algorithms are performed by existing computing methods. A qubit is embodied in various forms, e.g., a quantum dot, a neutral atom, a nitrogen vacancy (NV) center, a trapped ion, and a superconductor, and the DiVincenzo criteria should be satisfied to define a certain structure using qubits. Recent studies have demonstrated that quantum supremacy can be achieved using a superconducting qubit integrated quantum processor, and road maps for integration of a large number of qubits have been suggested to implement quantum computers.

Qubits are susceptible to external environmental interference and thus a coherence time, i.e., lifetime thereof, is finite. In addition, quantum superposition and quantum entanglement relate to analog calculation rather than digital calculation. Continuous feedback or feedforward measurements based on a quantum error correction (QEC) process are required to obtain high-fidelity results. To this end, multiple ancilla qubits are additionally required to operate a single high-fidelity qubit, and a process of repeatedly reading the ancilla qubits should be performed. Therefore, unless a coherence time of qubits is significantly improved, actually, a large number of physical qubits is required to operate a desired number of qubits, thus resulting in a burden of additional electric wirings and control equipment.

### SUMMARY OF THE INVENTION

In a qubit status reading apparatus of the related art, a number of electric wirings are required to provide qubits in an ultra-low temperature environment using a special device such as a dilution refrigerator to prevent undesired transition of an energy level due to thermal noise, provide probe signals to qubits, read generated signals, and control equipment. For example, at least 200 or more radio-frequency (RF) coaxial cables and a large number of pieces of equipment are required to drive and interpret 72 qubits.

Furthermore, after signals provided to qubits are down-converted, digital signal processing such as analog-to-digital conversion and a fast Fourier transform (FFT) is a heavy burden and it may be difficult to implement it on a large scale due to a large number of cables and rack equipment, and thus heat may leak and it may be impossible to maintain an ultra-low temperature environment and an ultra-low noise environment, thus resulting in overall system failure.

The development of cryo-CMOS front-end and digital electronic devices at a 4 K phase is being studied to overcome the above-described problems and implement quantum computers with large-scale qubits. This approach is aimed at solving problems such as utilization of limited space of a dilution refrigerator and a reduction of the number of physical electric wires at room temperature, and utilizing low thermal noise levels.

However, many resources, including space and cooling power, are consumed for cooling, and the burden of devices for digital signal processing is also a problem. Furthermore, heat leakage and latency are inevitable due to connection to external devices through a cable and transmission and reception of signals through the cable, but a coherence time is not long and thus the reliability of measurement of qubits is low due to the latency.

One aspect of embodiments set forth herein is to solve the above-described problem of the related art.

An aspect of the present invention provides a qubit state reading apparatus including a probe signal provider configured to provide a probe signal to a qubit and a readout module configured to receive a qubit signal output from the qubit to which the probe signal is provided and read a state of the qubit, in which the readout module includes a local oscillation (LO) signal generator configured to generate an LO signal, a mixer configured to down-convert the qubit signal using the LO signal, an accumulator configured to accumulate output signals of the mixer, and a comparator configured to compare an output signal of the accumulator with a threshold and output a signal corresponding to the state of the qubit, and the readout module down-converts the qubit signal and the LO signal in a homodyne manner.

In an embodiment, the qubit signal and the LO signal that are provided to the mixer may have the same frequency, wherein a difference between phases of the qubit signal and the LO signal due to a difference in path between the qubit signal and the LO signal is compensated for.

In an embodiment, the qubit state reading apparatus may further include an RF amplifier configured to amplify a signal provided to the qubit; and a transformer configured to perform impedance matching between the RF amplifier and the readout module and convert a signal output from the RF amplifier into a differential signal.

In an embodiment, the qubit state reading apparatus may further include a phase-locked loop (PLL) configured to form a signal with a first frequency, form signals at a second frequency by dividing the signal with the first frequency, and output the signal at the second frequency, and a divider configured to output divided signals obtained by dividing the signal with the first frequency, and each of the LO signal generator and the probe signal provider may include a phase accumulator configured to generate a low-speed clock with a lower frequency than a frequency of each of the divided signals when the division signals are provided in the form of a clock signal, and a mixer configured to up-convert the signal with the second frequency and the low-speed clock. For example, the qubit state reading apparatus may set the initial phase of the phase accumulator so that the probabilistic deviation of the comparator output value according to the state of the qubit is maximized.

In an embodiment, the accumulator may include an integrator configured to integrate output signals of the mixer.

In an embodiment, the qubit may be provided in a dilution refrigerator under an atmosphere of 10 mK or less, and the qubit state reading apparatus may be placed in the dilution refrigerator under an atmosphere of 4K or less.

Another aspect of the present invention provides a qubit state reading apparatus including a probe signal provider configured to provide a probe signal to a qubit, and a readout module configured to receive a qubit signal output from the qubit to which the probe signal is provided and read a state of the qubit, in which the readout module includes an LO signal generator configured to generate an LO signal, a mixer configured to down-convert the qubit signal and the LO signal, an accumulator configured to accumulate output signals of the mixer, and a comparator configured to compare an output signal of the accumulator with a threshold and output a signal corresponding to the state of the qubit, and the accumulator integrates the output signals of the mixer and outputs a result of integration.

In an embodiment, the accumulator may include a first chopper to which an output of the mixer is applied, an integrator configured to integrate outputs of the first chopper, and a second chopper to which an output of the integrator is applied. For example, the qubit state reading apparatus may read signals output from the qubit for a predetermined time period, and the first chopper and the second chopper may change a path of input signals for a part of the predetermined time period.

In an embodiment, the qubit signal may be a signal obtained by amplifying a signal output from the qubit by a parametric amplifier including a Josephson inductor and a capacitor. For example, the qubit signal may be further amplified by an amplifier including a high electron mobility transistor (HEMT) element and provided to the qubit state reading apparatus.

In an embodiment, the qubit signal and the LO signal that are provided to the mixer may have the same frequency, wherein a difference between phases of the qubit signal and the LO signal due to a difference in path between the qubit signal and the LO signal is compensated for. For example, the qubit state reading apparatus may down-convert the qubit signal and the LO signal in a homodyne manner.

In an embodiment, the qubit may be provided in a dilution refrigerator under an atmosphere of 10 mK or less, and the qubit may be provided in a dilution refrigerator under an atmosphere of 4 K or less.

Another aspect of the present invention provides a qubit state reading method including providing a probe signal to a qubit, receiving a qubit signal from the qubit to which the probe signal is provided, and demodulating the qubit signal, and reading a state of the qubit by accumulating signals output in the demodulating of the qubit signal, in which the demodulating of the qubit signal is performed in a homodyne manner using the LO signal whose phase and frequency are matched to a phase and frequency of the qubit signal.

In an embodiment, a difference between phases of the qubit signal and the LO signal due to a difference in path between the qubit signal and the LO signal may be compensated for. For example, the compensated-for phases of the qubit signal and the LO signal may be the same as a phase when probabilistic deviation of a result of the accumulating of the signals output in the demodulating of the qubit signal according to the state of the qubit is maximum.

In an embodiment, the reading of the state of the qubit may be performed by integrating the signals output in the demodulating of the qubit signal by an integrator.

In an embodiment, in the reading of the state of the qubit, integrating the signals by an integrator and changing a path of the signals by choppers located at an input terminal and an output terminal of the integrator may be performed together.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a state of an arrangement of a low-temperature qubit reading apparatus of an embodiment;

FIG. 2 is a schematic diagram illustrating an outline of a qubit reading apparatus of an embodiment;

FIG. 3 is a schematic timing diagram of an operation of a qubit reading apparatus of an embodiment;

FIG. 4 is a schematic block diagram of a probe signal provider and a local oscillation (LO) signal generator;

FIG. 5 is a diagram illustrating a frequency response of a readout resonator in a radio-frequency (RF) domain according to a state of a qubit before conversion to a baseband; and

FIG. 6 is a diagram showing a result of a simulation experiment conducted by a qubit reading apparatus of an embodiment.

### DETAILED DESCRIPTION

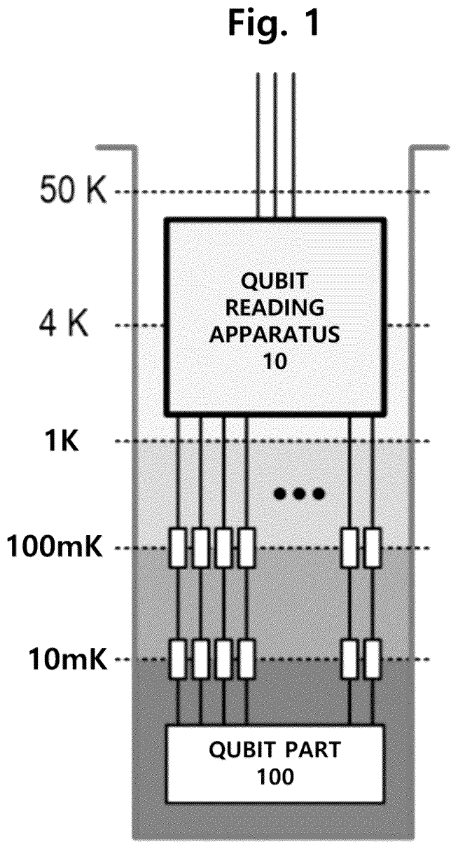

Hereinafter, embodiments will be described in detail with reference to the accompanying drawings. FIG. 1 is a schematic diagram illustrating a state of an arrangement of a low-temperature qubit reading apparatus 10 of an embodiment. Referring to FIG. 1, the low-temperature qubit reading apparatus 10 of the present embodiment is connected to a qubit part 100, which includes at least one qubit, through cables to apply probe signals for reading a state of a qubit and receive and read an output signal corresponding to the state of the qubit. As shown in an illustrated example, the qubit part 100 is maintained in an ultra-low temperature state of 10 mK or less, and the qubit reading apparatus 10 is located in a low temperature state of 4 K.

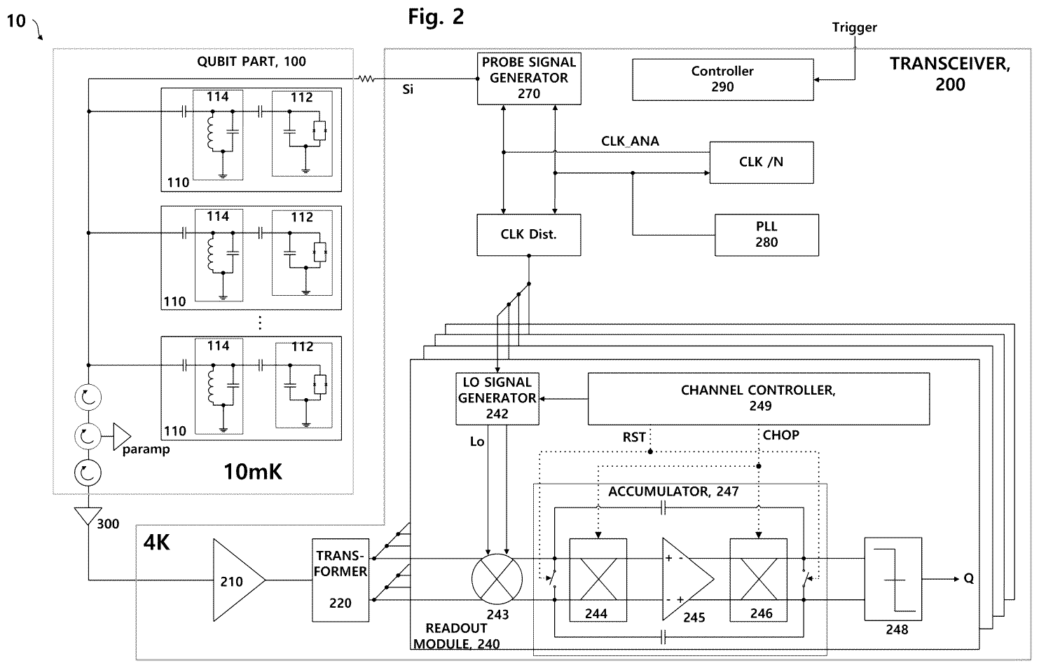

FIG. 2 is a schematic diagram illustrating a configuration of the qubit reading apparatus 10 of an embodiment. In the embodiment of FIG. 2, the qubit reading apparatus 10 includes a transceiver 200 that provides a probe signal to the qubit part 100 and receives a qubit signal from the qubit part 100. A probe signal Si is transmitted through a resistor for signal attenuation so that a noise level is reduced when a signal is transmitted to a lower-temperature environment in which the qubit part 100 is located from an environment in which a probe signal provider 270 is located.

The qubit part 100 includes four qubit modules 110 each including one qubit 112 and a read-out resonator 114. However, the above description is only intended to provide an example, and four or more qubit modules may form one qubit part. The qubit part 100 operates in a cryogenic environment of 10 mK or lower in a dilution refrigerator.

Each read-out resonator 114 has a different inductance value and/or a different capacitance value. Therefore, each read-out resonator 114 resonates at a different frequency. The probe signal provider 270 provides a multitone probe signal Si at a frequency corresponding to a resonance frequency of each read-out resonator 114, and thus each read-out resonator 114 resonates at the corresponding resonance frequency and the multitone probe signal Si is provided in each qubit 112.

A signal output from the qubit part 100 is provided to the transceiver 200 through a parametric amplifier paramp of a 10 mK range and a high electron mobility transistor (HEMT) low-noise amplifier 300 of a 4 K range. The parametric amplifier paramp is an amplifier that includes reactive elements such as a Josephson inductor and a capacitor, receives a signal of a resonant frequency, and amplifies and outputs the signal with low noise. Signals output from qubits are all added together and a result of the addition is output in an environment that is likely to interfere with noise, and thus the result of the addition is output after being amplified by a parametric amplifier with excellent noise characteristics.

A signal output from the qubit part 100 is provided to the transceiver 200 through the amplifier 300. In the illustrated embodiment, the amplifier 300 may be an amplifier including an HEMT formed of a material with high electron mobility by forming a two-dimensional electron gas (2-DEG). By using the amplifier 300 including the HEMT, additional contribution of noise can be minimized. In an embodiment, the amplifier 300 may include an element in which a hetero junction such as AlGaN/GaN or Si/Ge is formed.

The transceiver 200 includes a main controller 290 that controls the qubit reading apparatus 10 of the present embodiment. Although not shown, the main controller 290 provides a signal for control of each element of the transceiver 200 to identify a state of a qubit. The main controller 290 receives a trigger signal for operating the qubit reading apparatus 10 and operates the qubit reading apparatus 10 at a low temperature in response to the trigger signal.

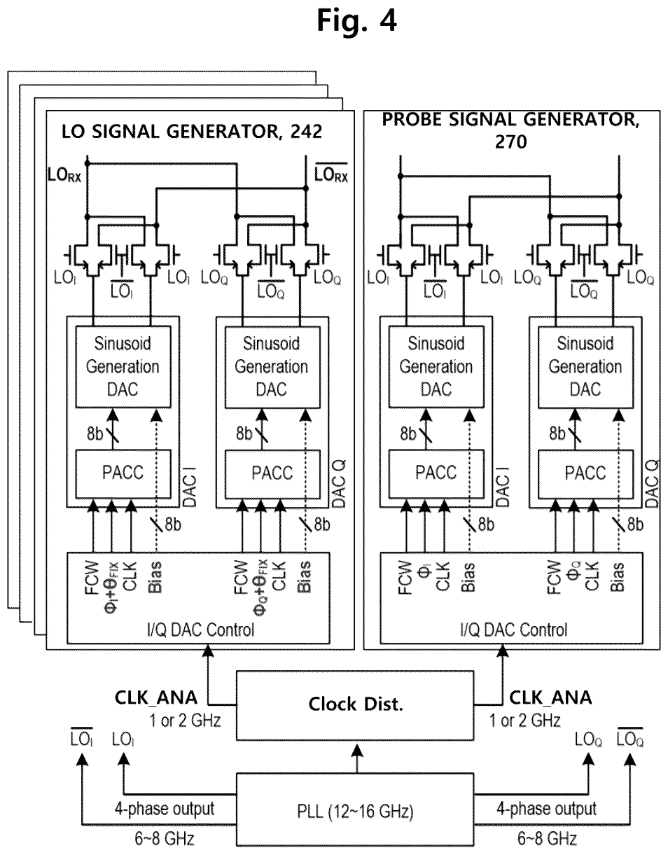

The transceiver 200 includes a phase-locked loop (PLL) 280. The PLL 280 generates a signal with a preset frequency and outputs the signal to a clock divider CLK/N. In addition, the PLL 280 may output 4-phase output signals (see FIG. 4) by dividing the preset frequency. The clock divider CLK/N divides a clock from the PLL 280 according to a predetermined division ratio to generate a divided clock signal CLK_ANA and provides the divided clock signal CLK_ANA to the probe signal provider 270 and a clock distributor.

In an embodiment, a frequency of a signal generated by and output from the PLL 280 may be, for example, in a range of 12 GHz to 16 GHz, frequencies of 4-phase output signals generated by and output from the PLL 280 may be in a range of 6 GHz to 8 GHz, and the clock divider CLK/N may divide a frequency of a signal supplied thereto by N to generate and output a signal with a frequency of 1 GHz to 2 GHz.

The clock distributor distributes and provides a clock provided from the clock divider CLK/N to each of readout modules 240. Accordingly, the probe signal provider 270 and a local oscillation (LO) signal generator 242 included in the readout module 240 are provided with the same divided clock signal.

The transceiver 200 includes an RF amplifier 210, a transformer 220, and readout modules 240 corresponding to the number of qubits. A signal output from and amplified by the qubit part 100 is amplified by the RF amplifier 210 and converted into a differential signal by the transformer 220, and the differential signal is output to the readout modules 240. The transformer 220 performs impedance matching between the RF amplifier 210 and the readout module 240 to improve signal transmission efficiency.

The qubit reading apparatus 10 of the present embodiment may include at least a number of readout modules 240 corresponding to the qubits 112 included in the qubit part 100. In the illustrated embodiment, the qubit part 100 includes four qubits 112. Accordingly, the qubit reading apparatus 10 of the present embodiment includes at least four readout modules 240.

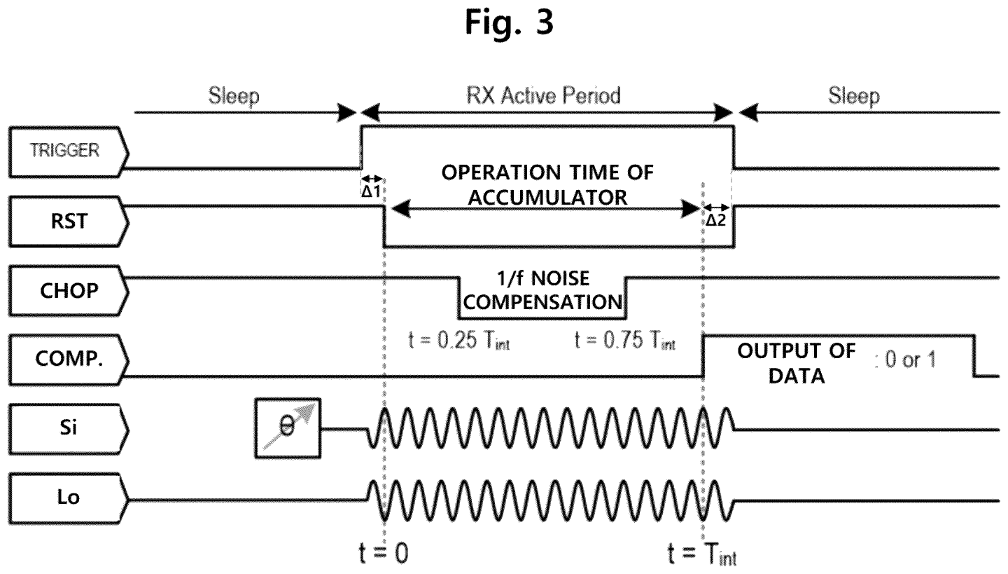

FIG. 3 is a schematic timing diagram of an operation of the qubit reading apparatus 10 according to the present embodiment, and FIG. 4 is a schematic block diagram of the probe signal provider 270 and the LO signal generator 242. An operation of the qubit reading apparatus 10 of the present embodiment will be described with reference to FIGS. 2 to 4 below. The qubit part 100 may be located in an atmosphere of 10 mK in a dilution refrigerator, and the transceiver 200 may be located in an atmosphere of 4 K in the dilution refrigerator and may be in a sleep state before a trigger signal is provided thereto. In the sleep state, switches located at input and output nodes of the accumulator 247 may be in a conducting state until a reset signal RST is provided. Thus, a capacitor included in an integrator 245 is discharged.

When a trigger signal Trigger is input to the main controller 290, the qubit reading apparatus 10 changes from the sleep state to a reception (RX) active period. After a rising edge of the trigger signal Trigger, the reset signal RST is supplied to the accumulator 247 to turn off the switches at the input and output nodes of the accumulator 247. Accordingly, the discharging of the capacitor included in the integrator 245 is completed, and the accumulator 247 may be activated to accumulate input signals. In the illustrated embodiment, the accumulator 247 may be activated after Δ1 at a first edge of the trigger signal Trigger.

FIG. 4 is a diagram schematically illustrating a probe signal generator 270 and an LO signal generator 212 of the present embodiment. Referring to FIGS. 2 to 4, the probe signal generator 270 outputs a probe signal Si to the qubit part 100 after Δ1 at a first edge of the trigger signal Trigger, and the LO signal generator 212 outputs a LO signal So whose phase difference with respect to the probe signal Si is compensated for.

The clock distributor outputs a divided clock CLK_ANA formed by the clock divider CLK/N to the probe signal provider 270 and the LO signal generator 242. The probe signal generator 270 and the LO signal generator 212 synthesize waveforms of 4-phase output signals LO_{I}, _LO_{I}, LO_{Q}, and _LO_{Q} formed by the PLL 280 and the divided clock CLK_ANA by a direct digital synthesis (DDS) method, and output a result of the synthesizing.

In an embodiment, the PLL 280 forms a signal at a frequency of 12 GHz to 16 GHz, divides the signal and outputs the 4-phase output signals LO_{I}, _LO_{I}, LO_{Q}, and _LO_{Q} at a frequency of 6 GHz to 8 GHz. The divided clock CLK_ANA at a frequency of 1 GHz to 2 GHz output from the clock divider CLK/N is provided to the probe signal generator 270 and the LO signal generator 212 through the clock distributor.

Each of the probe signal provider 270 and the LO signal generator 242 includes a phase accumulator, and the divided clock CLK_ANA is used as a clock of the phase accumulator and is divided by 8 to 12 to form a low-speed clock.

Each of the probe signal provider 270 and the LO signal generator 242 includes a mixer. The mixer up-converts the 4-phase output signals and the low-speed clock at a frequency of 7 GHz to form probe signals Si and a Lo signal. In an embodiment, when a frequency of the divided clock CLK_ANA is 1 GHz and the phase accumulator divides the divided clock CLK_ANA by 10 to form a low-speed clock at a frequency of 100 MHz, the mixers of the probe signal provider 270 and the LO signal generator 242 up-convert the divided clock CLK_ANA and the low-speed clock to form a probe signal Si of 7.1 GHz and a Lo signal. The phase accumulator may adjust an initial phase to control a phase of a low-speed clock signal formed by dividing the divided clock CLK_ANA. Accordingly, the phase of the probe signal Si and/or the phase of the LO signal formed by the probe signal provider 270 and/or the LO signal generator 242 may be controlled.

As illustrated in FIG. 4, the probe signal provider 270 and the LO signal generator 242 have similar circuit configurations. However, a path between the probe signal generator 270 and the qubit part 100, which is a path through which the probe signal Si output from the probe signal generator 270 passes, the sum of paths between the qubit part 100 and the transceiver 200, and a path through which the LO signal output from the LO signal generator 212 passes are different from one another in length. To compensate for a phase difference occurring in the mixer 243 due to such path differences, the LO signal generator 212 generates an LO signal to which a phase difference θ_{FIX} is added to compensate for the path differences.

In an embodiment, a phase difference caused by the difference in length between the sum of the paths between the qubit part 100 and the transceiver 200 and the path through which the LO signal output from the LO signal generator 212 passes is detected while changing an initial phase value of the phase accumulator. In an embodiment, it is determined that the phase difference is compensated for when probabilistic deviation of an output value of a comparator 248 is maximum for a case in which a state of a qubit is |0> or |1> after the probe signal SI is applied, and a low-speed clock is generated from an initial phase value in this case.

Although the LO signal generator 242 compensates for the signal by adding the phase difference θ_{FIX} corresponding to the path difference in the illustrated embodiment, the probe signal generator 270 may remove an influence due to the path difference by adding the phase difference in an embodiment (not shown).

The mixer 243 included in the readout module 240 down-converts a signal corresponding to a state of qubits output from the qubit part 100 and the LO signal output from the LO signal generator 242 into baseband signals in a homodyne manner.

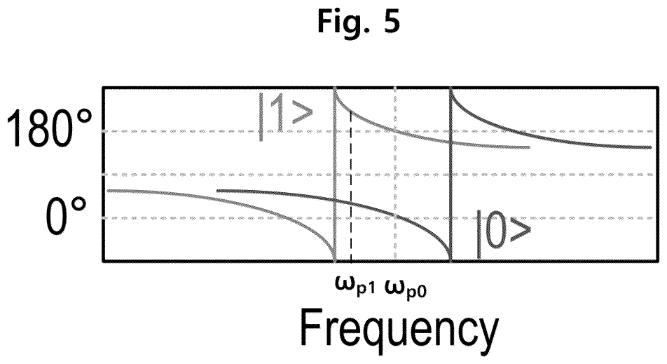

FIG. 5 is a diagram illustrating a frequency response of a readout resonator in an RF domain before conversion to a baseband, according to a state of a qubit. Referring to FIG. 5, in an embodiment, when a state of a qubit is |1>, a signal with a phase of 180 degrees is output when a signal with a frequency of ωₚ₀ is applied to the readout resonator 110. However, when the state of the qubit is |0>, a signal with a phase of 0 degrees is output when a signal with a frequency of ωₚ₀ is applied to the readout resonator 110. Therefore, a signal output from the qubit may be 180 degrees out of phase according to the state of the qubit, signals output from the qubit may be accumulated, and the state of the qubit may be identified from the accumulated signals.

However, when the state of the qubit is |1>, a signal with a relatively large amplitude is output when a signal with a frequency of ωₚ₁ is applied to the readout resonator 110. However, when the state of the qubit is |0>, a signal with a relatively small amplitude is output when the signal with the frequency of ωₚ₁ is applied to the readout resonator 110. Accordingly, the state of the qubit may be identified by accumulating signals output from the qubit according to the state of the qubit.

Referring back to FIGS. 2 and 3, signals output from the mixer 243 are accumulated in the accumulator 247 and output to the comparator 248. The comparator 248 compares an input signal with a reference value and outputs a signal Q corresponding to the state of the qubit. The accumulator 247 may include the integrator 245, and the integrator 245 accumulates inputs and noise over time. Because a time average of noise is close to zero, a signal-to-noise ratio (SNR) of a signal may be increased by accumulating signals with superimposed noise components. However, as an integration time increases, gate fidelity may eventually decrease due to decoherence of the qubit and thus the integration time should be controlled.

The integrator 245 may include a differential operation amplifier to which a differential input is provided and a capacitor connected in a negative feedback manner in relation to an input and an output of the differential operation amplifier. The SNR of the signal output through the accumulator 247 may be expressed by Equation 1 below.

$$SNR ( t ) = \frac{{[ S ( t ) ]}^{2}}{N ( t )} = \frac{4 {τΔ}^{2}}{{N}_{0}} tanh ( \frac{t}{2 τ} ) \approx \frac{2 {Δ}^{2}}{{N}_{0}} t [ 1 - {( \frac{t}{2 τ} )}^{2} ] \qquad [ Equation 1 ]$$

(τ: a time constant of an integrator, t: an integration time of the integrator, N₀: power spectrum density of input thermal noise, Δ: an input amplitude of the integrator)

In Equation 1 above, when the integration time t of the integrator is fixed, an SNR improves as the time constant T of the integrator increases. When 2τ>>t, the SNR is at a maximum level of 2Δ2t/N₀. However, when the time constant τ of the integrator is large, a time delay occurs until the integrator forms a desired output. In addition, an output that is large enough for the comparator 248 to reliably identify the state of the qubit should be ensured. Therefore, the time constant of the integrator may be a design parameter for trade-off between an SNR and an output when an integration time is given.

In an embodiment, the accumulator 247 may further include a first chopper 244 and a second chopper 246. A channel controller 249 outputs a chopper operation signal CHOP at a point in time corresponding to a first 25% of an operating section of the accumulator 247 after operation of the accumulator 247 to operate the first chopper 244 and the second chopper 246. The first chopper 244 and the second chopper 246 are operated again at a point in time corresponding to the first 75% of the operating section of the accumulator 247 after operation of the accumulator 247. As the first chopper 244 and the second chopper 246 operate, a path of a signal input to the operation amplifier 245 may be changed, an influence of low-frequency noise may be offset, and switching noise due to an offset level may be minimized.

In the sleep state, the switches at the input and output terminals of the accumulator 247 are in a conducting state. Accordingly, a capacitor in a negative feedback path of the operation amplifier 245 may be discharged, and when the reset signal RST is provided, the switches are turned off and thus signals input through the capacitor in the negative feedback path of the operation amplifier 245 may be accumulated and output. For example, the integrator 245 may output a signal that is provided from the mixer and accumulated, and output a signal that increases or decreases over time.

Next, at a predetermined point in time Tint, the channel controller 249 provides a comparator control signal comp to operate the comparator 248. The comparator 248 compares a signal output from the accumulator 247 with a reference value and outputs a signal Q corresponding to a comparison result. In an embodiment, the reference value may be a ground-level signal.

In an embodiment, the comparator 248 is activated in response to the comparator activation signal COMP (not shown), which is a latch type signal, to latch up and output an output signal of the accumulator 247. In an embodiment, the comparator 248 further includes a 6-bit binary digital-to-analog converter (DAC). The DAC compensates for a constant DC offset due to an offset thereof. Furthermore, in the sleep state, outputs may be compared and a 6-bit DAC may be adjusted to compensate for a long-term offset more quickly.

Conventionally, a state of qubits is identified by converting signals output from the qubits into intermediate frequency (IF) band signals and performing signal processing on the IF band signals or down-converting the IF band signals into baseband signals and performing signal processing on the baseband signals. In addition, it is difficult to identify the state of the qubits with high reliability due to problems such as heat leakage and latency, caused by operation of hardware and lines for performing signal processing.

However, as described above, in the present embodiment, the probe signal Si from the qubit part 100 and the LO signal Lo for demodulating the probe signal Si are provided after a phase difference therebetween is compensated for at the same frequency, and thus a hardware configuration may be simplified and a burden of cables may decrease to reduce problems due to latency and the lifespan of the qubits, thereby enabling the state of the qubits to be identified with higher reliability than in the related art.

### Result of Simulation Experiment

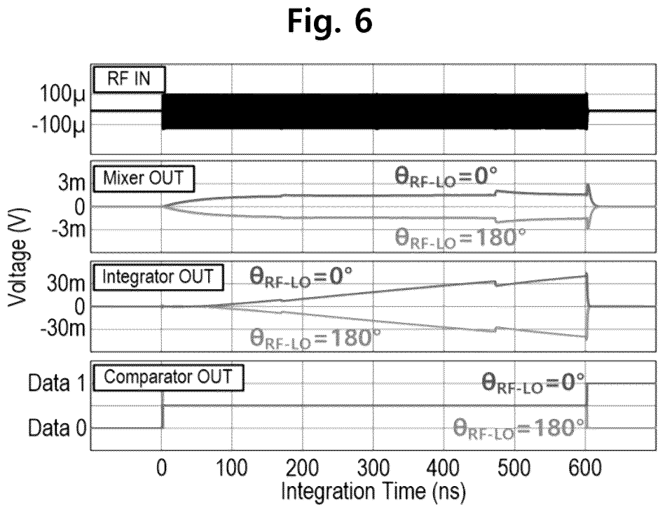

FIG. 6 is a diagram showing a result of a simulation experiment conducted with the qubit reading apparatus 10 according to the present embodiment. Referring to FIG. 6, a signal output from a qubit was applied for 0 to 600 nsec. MIXOUT denotes signals obtained by mixing an LO signal and the signal output from the qubit by a mixer and converting a resultant signal into a baseband signal for the same time period, and it was confirmed that values of the signals MIXOUT varied according to a state of the qubit.

Signals MIXOUT output from the mixer were accumulated by being provided to an accumulator. It can be seen from FIG. 6 that values were accumulated according to the state of the qubit. As described above, it can be seen that choppers operated at 25% and 75% of a section, thus causing glitches.

Thereafter, it can be seen that after 600 nsec, a comparator operated and output data 1 or 0 according to the state of the qubit.

According to the present invention, a burden of cables and devices and the loss of heat when a state of a qubit is read out can be minimized, unlike in the related art.

Although the embodiments illustrated in the drawings have been described above to help understand the present invention, these embodiments are only examples and it will be apparent to those of ordinary skill in the art that various modifications may be made and other equivalent embodiments are derivable from the embodiments. Therefore, the scope of the present invention should be defined by the appended claims.

What is claimed is:

1. A qubit state reading apparatus comprising:
a probe signal provider configured to provide a probe signal to a qubit; and
a readout module configured to receive a qubit signal output from the qubit to which the probe signal is provided and read a state of the qubit,
wherein the readout module comprises:
a local oscillation (LO) signal generator configured to generate an LO signal;
a mixer configured to down-convert the qubit signal using the LO signal;
an accumulator configured to accumulate output signals of the mixer; and
a comparator configured to compare an output signal of the accumulator with a threshold and output a signal corresponding to the state of the qubit, and
the readout module down-converts the qubit signal and the LO signal in a homodyne manner.

2. The qubit state reading apparatus of claim 1, wherein the qubit signal and the LO signal that are provided to the mixer have the same frequency, wherein a difference between phases of the qubit signal and the LO signal due to a difference in path between the qubit signal and the LO signal is compensated for.

3. The qubit state reading apparatus of claim 1, further comprising:
a radio-frequency (RF) amplifier configured to amplify a signal provided to the qubit; and
a transformer configured to perform impedance matching between the RF amplifier and the readout module and convert a signal output from the RF amplifier into a differential signal.

4. The qubit state reading apparatus of claim 1, further comprising:
a phase-locked loop (PLL) configured to form a signal with a first frequency, form signals with a second frequency by dividing the signal with the first frequency, and output the signals with the second frequency; and
a divider configured to output the divided signals obtained by dividing the signal at the first frequency,
wherein each of the LO signal generator and the probe signal provider comprises:
a phase accumulator configured to generate a low-speed clock with a lower frequency than a frequency of each of the divided signals when the division signals are provided in the form of a clock signal; and
a mixer configured to up-convert the signals with the second frequency and the low-speed clock.

5. The qubit state reading apparatus of claim 4, wherein an initial phase of the phase accumulator is set to maximize probabilistic deviation of an output value of the comparator according to the state of the qubit.

6. The qubit state reading apparatus of claim 1, wherein the accumulator comprises an integrator configured to integrate output signals of the mixer.

7. The qubit state reading apparatus of claim 1, wherein the qubit is provided in a dilution refrigerator under an atmosphere of 10 mK or less, and
the qubit state reading apparatus is placed in the dilution refrigerator under an atmosphere of 4 K or less.

8. A qubit state reading apparatus comprising:
a probe signal provider configured to provide a probe signal to a qubit; and
a readout module configured to receive a qubit signal output from the qubit to which the probe signal is provided and read a state of the qubit,
wherein the readout module comprises:
a local oscillation (LO) signal generator configured to generate an LO signal;
a mixer configured to down-convert the qubit signal and the LO signal;
an accumulator configured to accumulate output signals of the mixer; and
a comparator configured to compare an output signal of the accumulator with a threshold and output a signal corresponding to the state of the qubit, and
the accumulator integrates the output signals of the mixer and outputs a result of integration.

9. The qubit state reading apparatus of claim 8, wherein the accumulator comprises:
a first chopper to which an output of the mixer is applied;
an integrator configured to integrate outputs of the first chopper; and
a second chopper to which an output of the integrator is applied.

10. The qubit state reading apparatus of claim 9, wherein the qubit state reading apparatus reads signals output from the qubit for a predetermined time period, and
the first chopper and the second chopper change a path of input signals for a part of the predetermined time period.

11. The qubit state reading apparatus of claim 8, wherein the qubit signal is a signal obtained by amplifying a signal output from the qubit by a parametric amplifier including a Josephson inductor and a capacitor.

12. The qubit state reading apparatus of claim 11, wherein the qubit signal is further amplified by an amplifier including a high electron mobility transistor (HEMT) element and provided to the qubit state reading apparatus.

13. The qubit state reading apparatus of claim 8, wherein the qubit signal and the LO signal that are provided to the mixer have the same frequency wherein a difference between phases of the qubit signal and the LO signal due to a difference in path between the qubit signal and the LO signal is compensated for.

14. The qubit state reading apparatus of claim 13, wherein the qubit state reading apparatus down-converts the qubit signal and the LO signal in a homodyne manner.

15. The qubit state reading apparatus of claim 8, wherein the qubit is provided in a dilution refrigerator under an atmosphere of 10 mK or less, and
the qubit state reading apparatus is provided in a dilution refrigerator under an atmosphere of 4 K or less.

16. A qubit state reading method comprising:
providing a probe signal to a qubit;
receiving a qubit signal from the qubit to which the probe signal is provided, and demodulating the qubit signal; and
reading a state of the qubit by accumulating signals output in the demodulating of the qubit signal,
wherein the demodulating of the qubit signal is performed in a homodyne manner using the LO signal whose phase and frequency are matched to a phase and frequency of the qubit signal.

17. The qubit state reading method of claim 16, wherein a difference between phases of the qubit signal and the LO signal due to a difference in path between the qubit signal and the LO signal is compensated for.

18. The qubit state reading method of claim 17, wherein the compensated-for phases of the qubit signal and the LO signal are the same as a phase when probabilistic deviation of a result of the accumulating of the signals output in the demodulating of the qubit signal according to the state of the qubit is maximum.

19. The qubit state reading method of claim 16, wherein the reading of the state of the qubit is performed by integrating the signals output in the demodulating of the qubit signal by an integrator.

20. The qubit state reading method of claim 16, wherein, in the reading of the state of the qubit, integrating the signals by an integrator and changing a path of the signals by choppers located at an input terminal and an output terminal of the integrator are performed together.
